(19) United States
(12) Patent Application Publication
(10) Pub. No.: US 2020/0056078 A1
(43) Pub. Date: Feb. 20, 2020

(54) JOINT SEALING COMPOUND AND TOOL FOR THE TREATMENT THEREOF AND SET AND ILLUMINATING MEANS

(71) Applicant: KDS HOLDING GMBH, WESSELING (DE)

(72) Inventor: DINKO JURCEVIC, KOELN (DE)

(73) Assignee: KDS HOLDING GMBH, WESSELING (DE)

(21) Appl. No.: 16/485,167

(22) PCT Filed: Feb. 13, 2018
(86) PCT No.: PCT/DE2018/100122

§ 371 Date: Oct. 16, 2019

Related U.S. Application Data
(60) Provisional application No. 62/548,485, filed on Aug. 22, 2017.

(30) Foreign Application Priority Data
Feb. 13, 2017 (DE) 20 2017 100 765.0
Feb. 13, 2017 (DE) 20 2017 100 766.9
Aug. 22, 2017 (DE) 20 2017 105 039.4
Oct. 17, 2017 (DE) 20 2017 106 299.6
Feb. 12, 2018 (DE) 20 2018 100 748.3

(51) Int. Cl. C09K 3/10; C08G 18/81; C08K 3/36; C08K 5/45; C08K 13/02; E04F 21/165; F21V 33/00

(52) U.S. Cl. CPC C09K 3/1021; C08G 18/8125; C08K 3/36; C08K 5/45; F21Y 2115/10; E04F 21/1652; F21V 33/0084; C09K 2200/065; C08K 13/02

(57) ABSTRACT

A joint sealing compound for the in-situ production of connection joints in wet areas. The joint sealing compound is based on acrylates. The joint sealing compound is either light-curable only with a light which is outside of the UV range, or the joint sealing compound is curable via a dual-curing process wherein the joint sealing compound is moisture-curing with a light which is outside of the UV range.

### CROSS REFERENCE TO PRIOR APPLICATIONS

This application is a U.S. National Phase application under 35 U.S.C. § 371 of International Application No. PCT/DE2018/100122, filed on Feb. 13, 2018 and which claims benefit to German Patent Application No. 20 2017 100 766.9, field on Feb. 13, 2017, to German Patent Application No. 20 2017 100 765.0, filed on Feb. 13, 2017, to German Patent Application No. 20 2017 105 039.4, filed on Aug. 22, 2017, to U.S. Provisional Patent Application No. 62/548,485, filed on Aug. 22, 2017, to German Patent Application No. 20 2017 106 299.6, filed on Oct. 17, 2017, and to German Patent Application No. 20 2018 100 748.3, filed on Feb. 12, 2018. The International Application was published in German on August 16, 2018 as WO 2018/145700 A2 under PCT Article 21(2).

### FIELD

The present invention relates to a joint sealing compound which is used in particular for the production of connection joints in rooms, for example, within the scope of interior fitting, for example, in sanitary facility and/or kitchen areas, and to a tool for treatment of the joint sealing compound, to a set, and to an illuminating device.

### BACKGROUND

Connection joints are understood to be joints that are created where two different components meet one another, and the gap formed must be closed. The best-known connection joints can be found in sanitary areas, for example, as a connection between a shower tray, bathtub or wash basin and the wall or the floor.

The silicones currently used for high-moisture rooms or areas for the production of joints, in particular connection joints, are water-resistant, but have a long curing time, are very odorous (separation of acetic acid), and cannot be painted over. A further disadvantage of silicone-based joint sealing compounds is that they are not resistant to the descalers commonly used in bathroom, sanitary facility and kitchen areas. Biocides must also be added to these compounds in order to make them resistant to mildew.

Acrylic is used in the form of acrylic joint sealing compound for connection joints or for the filling and sealing of expansion joints or stress cracks. Conventional acrylates, however, have a long curing time, are only partially water-repellent, and should therefore not be used in wet areas in which there is a high moisture level. Since conventional acrylic sealing compounds are water-based and dissolve in water, acrylic sealing compounds of this kind cannot be used for connection joints in wet areas. Due to their water content, they constantly lose moisture over time and continue to cure increasingly, thus resulting in the known stress cracks.

In contrast to silicone, acrylic is odor-neutral and can be painted over.

DE 20 2008 007 910 U1 describes a joint sealing compound which, amongst other things, can contain an acrylic resin and is used for renewing joints between paving slabs in exterior areas in order to provide a permanent and weather-resistant sealed joint.

DE 10 2015 000 237 A1 describes a material for sealing, isolating and/or caulking areas of damage, drill holes in building facades, and for caulking joints, wherein the material is or comprises a synthetic resin in the form of acrylic resin and/or a silicone resin, in which hollow microspheres made of glass, ceramic and/or glass ceramic are incorporated. The sealing and creation of joints in interior areas, in particular in wet areas (shower trays, baths, wash basins, shower screens of all types), should also be possible with the aforementioned material.

The above-described materials have a long curing time, which is disadvantageous.

Silicone-based or acrylic-based UV-curable materials that are cured with a UV lamp (usually a mercury vapor lamp) are also known from the prior art, wherein an extraction system is necessary on account of the creation of ozone. It is also necessary to wear special protective goggles to avoid eye damage caused by the UV radiation. A further disadvantage of the mercury vapor lamps often used for this purpose is the development of heat on account of the IR radiation, which can lead to problems in the case of temperature-sensitive substrates.

DE 10 2006 006 334 A1 describes a urethane acrylate which is suitable for materials curable by active radiation and/or thermally radically curable materials, or is suitable for the production of such materials, and has a low viscosity. These materials should above all be suitable as new coating materials, adhesives, sealing compounds and precursors for molded parts and films, curable by actinic radiation and/or thermally radically curable, wherein only the coating materials for the coil-coating method will be discussed primarily in the description. The applied, new coating materials curable by actinic radiation and/or thermally radically curable should cure by actinic radiation and/or should cure thermally radically quickly and without polymerization shrinkage, or with such a small polymerization shrinkage that the desired property profile is not influenced or is not considerably influenced, and should provide new thermosetting coatings, in particular shiny, clear transparent and matt transparent coatings as well as shiny opaque and matt opaque coatings with an excellent property profile. The polyurethane acrylates can further be used later as raw materials in various end products. These raw materials are then used under the product name “Laromer®” in order to produce various end products and obtain the desired properties necessary for production of the end products (for example, also sealants) only as a result of the correct combination with other raw materials. Reference is made again to the advantages of a low viscosity. These materials are not suitable as joint sealing compounds, amongst other things due to the low viscosity, since the joint sealing compound must not run during application and should have a defined stability. The type of curing is furthermore not suitable for the intended application, since the urethane acrylates used in the prior art do not contain any isocyanate groups, which are necessary, for example, for a dual-curing method (both reaction under UV-LED radiation and a post-cross-linking by air humidity).

DE 20 2015 106 261 U1 describes a UV-curable seal for a housing, in particular an acrylate formulation for producing a UV-curable seal for an aluminum housing in the engine compartment of cars. The following constituents are used:
a) at least one polyfunctional urethane resin (70-80%),
b) at least one monofunctional acrylate (15-20%),
c) at least one trifunctional acrylate,
and additives and initiators,
d) rheology additive (4-7%),
e) additives (0-3%),
f) photo-initiator, in particular UV initiator (0.1-3%).

UV light is used for curing, however, this has the significant disadvantage of ozone formation, thereby necessitating an extraction system. Known UV lamps or flashlights are used.

This composition is not suitable for in-situ joints (connection joints) in wet areas.

DE 6 02004 006 112 T2 describes moisture-curing silicone for seals, wherein moisture-curing organopolysiloxane, 32-70 wt.-% (non-yellowing), and a photocatalyst (titanate), are used. This material is also intended to act as a protective layer at the interface to air. Since no light-curing urethane acrylates are used, a long curing time is provided.

DE 69 322 428 T2 describes a UV-cross-linking material for sealing, which in accordance with an exemplary embodiment cross-links over a number of days. An organolithium reagent is here used as a catalyst for producing materials with terminal alkoxy silyl (this results in an independent silanol). The moisture cross-linking occurs in the Si scaffold via the alkoxy group (organopolysiloxane). Methacryloxypropyltrimethoxysilane is used, inter alia, as an adhesion promoter, wherein the synthesis of the material occurs in a complex manner in a reactor. Highly volatile materials are produced which are suctioned off under vacuum. This is thus a very complex process. UV curing is also disadvantageous on account of the health risks. This material is likewise not suitable for the production of joints in a domestic setting.

A polymer matrix (also for joints) is described in DE102008000353 A1 which is composed on the basis of silicones or contains organic polymers and siloxanes. Compounds which, as they are irradiated, furthermore release energy-rich radiation, for example, UV light or electronic radiation, can also be used to break down protons. In accordance with exemplary embodiment 10, the UV curing of a polymer mix with silicone oil forms a tack-free coating, or the curing occurs under the influence of temperature (here 140° C. for 5 minutes), wherein a tack-free coating is likewise formed.

The known disadvantages of the UV-curing materials also occur here, for example, odor development and the necessary extraction system, and the curing occurs under the influence of heat. The catalysts mentioned here release protons under UV light, which protons support the reaction but are not usable in the radical polymerization.

The key disadvantage of these conventional materials and sealants lies in the fact that they require a long curing time, usually lasting from several hours to days, and are either moisture-curing (long curing time) or are UV-curing. In the case of the UV-curing materials, particular precautions must be taken in order to avoid an endangerment to health.

The materials disclosed in the prior art are not always suitable for joint-sealing in sanitary facility or kitchen areas, or, after the joint sealing, a shower provided, for example, with a silicone joint would only be usable again after a relatively long drying time.

In the case of exclusively UV-curing materials, shaded areas would not cure.

A rapidly curing joint sealing compound for producing connection joints in wet areas within the scope of interior fitting (for example, sanitary facility and kitchen areas) is not disclosed with the solutions described in the prior art.

In order to produce or smooth the joint sealing compound introduced into a connection joint, joint tools are currently used, also referred to as joint spatulas, joint smoothing trowels, joint skimmers, joint scrapers, silicone spatulas and the like. These are used, for example, to produce connection joints in sanitary facility and kitchen areas and in masonry, concrete, plasterboard, etc., wherein the joint sealing material or the joint sealing compound introduced into the joints is skimmed and/or smoothed using the joint tool.

The known joint skimmers are a planar or disc-like tool, usually made of plastic, with at least one skimming edge, which is used to skim the joint material introduced into the joint. Depending on the dimensions and shape of the skimming corner, a connection joint having a specific cross-sectional shape is created.

For sealing or for smoothing joints, joint-smoothing spatulas according to DE 10 2015 103 842 A1 are used, for example, which have a holding body and a smoothing body.

Joint skimmers which comprise a lamp for illuminating the working area so as to thus also be able to work in the dark or in unfavorable lighting conditions are also known, for example, from CN 105696779 A, however, they are not suitable for the rapid curing, within just a few seconds, of materials based on acrylic or silicone with photo-initiator.

DE 20 2012 100 929 U1 describes a modelling and curing device for processing a light-curing material, via which device it is already possible to model and cure a light-curing material in a single process step. A holder here comprises a grip and an LED lamp holder, and a smoothing device in the form of a spatula is also is arranged on the holder. The smoothing area of the smoothing device has a flat form, but can also contain recesses. The LED lamp holder can be fitted into a mount.

The fitting of the LED lamp holder into the LED mount, which is arranged in the grip area in the direction of the smoothing device, is unfavorable, however, for the handling in the operator area, and it is not possible to remove and re-fit the holder easily and quickly.

### SUMMARY

An aspect of the present invention is to provide a joint sealing compound and a tool for the treatment thereof, and also a set and an illuminating device, with the aid of which it is possible to cure in-situ (on-site) freshly filled joints, in particular connection joints for sanitary facility and/or kitchen areas and interior fitting, within a few seconds to minutes, so that immediate use or further treatment, for example, painting, is possible.

In an embodiment, the present invention provides a joint sealing compound for the in-situ production of connection joints in wet areas. The joint sealing compound is based on acrylates. The joint sealing compound is either light-curable only with a light which is outside of the UV range, or the joint sealing compound is curable via a dual-curing process wherein the joint sealing compound is moisture-curing with a light which is outside of the UV range.

### BRIEF DESCRIPTION OF THE DRAWINGS

The present invention is described in greater detail below on the basis of embodiments and of the drawings in which:

FIG. 1 shows a joint tool in a side view;

FIG. 2 shows a joint tool according to FIG. 1 in a plan view;

FIG. 3 shows a skimming element with a straight skimming edge;

FIG. 4 shows a skimming element with a skimming edge extending in the radius;

FIG. 5 shows a skimming element with a skimming edge extending at an angle of 90°;

FIG. 6 shows a joint tool with a skimming element which is fastened to a lamp in the form of a flashlight via a plug-in connection, during use;

FIG. 7 shows a joint tool which is “can-like”, with a removable skimming element and a plurality of LEDs;

FIG. 8 shows a variant of a skimming element with a protrusion extending relative to the skimming edge for insertion into a lamp or a grip,

FIG. 9 shows a further variant of a skimming element;

FIG. 10 shows a joint tool formed of an LED lamp and skimming element which can be fitted onto a finger;

FIG. 11 shows a depiction of a further variant of a joint tool;

FIG. 12 shows a joint tool according to FIG. 11 in use;

FIG. 13 shows a set of a joint tool formed from a flashlight-like LED lamp with an assembled skimming element and further non-assembled skimming elements;

FIG. 14 shows a joint tool formed from a grip having one or more LEDs on the front end and with skimming element received rotatably on the grip, which skimming element has two different skimming edges which are arranged at an angle of 180° to one another, i.e., opposite one another;

FIG. 15 shows a joint tool with a grip, to which a skimming element is connected pivotably via a ball joint, wherein the LED is fastened to the skimming element, in a plan view;

FIG. 16 shows a joint tool with a grip, to which a skimming element is connected pivotably via a ball joint, wherein the LED is fastened to the skimming element, in a side view;

FIG. 17 shows a joint tool in which a lamp with an LED has been clipped to a skimming element; and

FIG. 18 shows a set formed from joint material, an LED lamp, and a skimming element.

### DETAILED DESCRIPTION

The joint sealing compound is in particular used for connection joints in wet areas, such as sanitary facility and special kitchen areas, and therefore in particular within the scope of interior fitting for the production of in-situ joints, wherein the joint sealing compound in accordance with the present invention is either a merely light-curing acrylic-based material or a light-curing and moisture-curing (curing in the dual-curing process) acrylic-based joint material.

The acrylate-based joint sealing compound consists of a clear or light-permeable or translucent material if it is light-curing in a single-step process with light outside the UV range. This is also referred to as a radical process (radical polymerization).

If joints that are accessible over their entire length and width to an appropriate radiation are produced using this joint sealing compound, they cure already in a single-step process by the action of light (light outside the UV range, in particular violet to blue light), if the joint sealing compound consists of a clear, but at least translucent material. It is possible to paint over the joint sealing compound introduced into the connection joint once the compound has been smoothed and has cured.

If the joint sealing compound consists of a substantially light-impermeable material or of a material that is not translucent or is not completely translucent, or if the joint filled/passed over with the joint sealing compound in situ is not accessible over its entire length and/or width for light irradiation, the joint sealing compound introduced into the joint is cured in a two-step curing process in the form of a dual-curing process in which a first (partial) curing with light outside the UV range and a subsequent curing by way of a moisture curing are performed. This material can, for example, comprise color pigments, via which a certain coloration of the joint sealing compound is achieved. As a result of the used color pigments, the curing light does not act through the entire applied thickness of the joint sealing compound introduced into the joint, and it is not possible for the curing light acting thereon (for example, light in the violet to blue range) to completely cure the joint sealant. Via the irradiation of the light-curing material with the dual-curing process, a surface curing is thus firstly achieved by way of the action of the light. The joint sealing compound is thus cured after just a few seconds to minutes, so that the area can be returned to use or, in the case of construction projects, other trades can perform their work. In the next step of the process, the joint sealing compound can now be cured fully by moisture curing.

The approximate formulation of the radical system, i.e., the acrylate-based joint sealing compound that can be cured solely by light curing, will be described hereinafter:
70-95 wt.-% difunctional urethane acrylate,
0-5 wt.-% photo-initiator TPO-L (ethyl (2,4,6-trimethylbenzoyl) phenyl phosphinate),
0-5 wt.-% photo-initiator Keycure 981 (bis(2,4,6-trimethylbenzoyl)-phenylphosphine oxide),
0-5 wt.-% optical brightener Tinopal OB CO (2,5-thiophenediylbis (5-tert-butyl-1,3-benzoxazole),
10-20 wt.-% plasticizer (K-Flex 500), and
1-10 wt.-% silane JH-O174 (3-(methacryloxyl)propyltrimethoxysilane).

The joint sealing compound based on the radical system can also contain fungicide and/or various pigments for coloration, wherein, in spite of the color pigments, a translucent or at least partially translucent joint sealing compound should be provided, so as to provide complete or practically complete curing as a result of the action of the light irradiation. The used urethane acrylate can be a mixture of different types of urethane acrylates.

The joint sealing compound curable in the dual-curing process is in particular a material that cures under the action of a polymerizing radiation, in the form of aliphatic isocyanate-functional urethane acrylates and at least one photo-initiator in an amount of from 0.5 to 8 wt.-% (wt.-%; percentage by weight within the scope of the present invention is to be understood to mean the mass fraction), and firstly polymerizes partially under radical photopolymerization and then post-cross-links in a further curing process by an NCO/OH reaction.

Via the first curing process of the joint sealing compound by photopolymerization under the action of radiation, for example, via light, the joint sealing compound already cures to an extent in particular of 40-80%. The post-cross-linking then occurs, for example, over a few hours by moisture curing, wherein immediate use or further treatment (painting) is possible.

The joint sealing compound can, for example, contain 20 to 70 wt.-% of aliphatic isocyanate-functional urethane acrylates and 10 to 40 wt.-% of aliphatic urethane acrylates and in particular at least one photo-initiator, for example, in an amount of from 0.5 to 8 wt.-%.

The photo-initiator provides that the joint sealing material is cured when the joint sealing material is irradiated with radiation in a range of from 300 to 600 nanometers (nm), in particular in the range of from 450 to 480 nm, in particular at 470 nm, and, for example, in a range of from 390 to 410 nm, and thus outside the UV range (in particular in the violet to blue light range).

A first curing of the material to achieve a ready-to-use state is here performed within a few seconds to minutes. This can be achieved, for example, with the aid of a light-emitting device, in particular in the form of a polymerization lamp, such as an LED or an LED chip, which, for example, are provided in an LED illuminating device, such as an LED lamp.

With use of a joint sealing compound that is merely a light-curing joint sealing compound by way of a radical system, and also with a joint sealing compound that cures in the dual-curing process, it should be provided that the joint sealing compound has a high elongation, as is also provided in the case of conventional silicone-based joint materials for connection joints in wet areas (such as bathroom and/or sanitary facility and/or kitchen areas).

In accordance with the present invention, curing takes place following the application of the joint sealing compound only if the radiation of the light-emitting device (in particular the LED) impinges on the joint sealing compound. This results in the possibility of simple repair following application and prior to curing.

The curing via the polymerization lamp can, for example, occur in a light spectrum outside the UV range, which is harmful to health, wherein there is no need for any protective equipment, in particular, in the violet to blue light spectrum.

There is thus no need for any protective goggles, as required for UV applications at a distance of less than 80 cm, and there is no need to provide an extraction system, which must be used in the case of UV radiation due to the formation of ozone.

A further advantage of the solution according to the present invention lies in the fact that there is no development of unpleasant odors in the treatment of the joint sealing material according to the present invention.

The solution according to the present invention is thus intended for the in-situ sealing of joints on-site by tradesmen and in the DIY sector.

A first curing is achieved after just 2-20 s of irradiation with the polymerization lamp and already allows use of the room or the joint-sealed areas to be resumed, or allows a further treatment. Complete curing within the scope of a radical process or within the scope of a dual-curing process, in which the post-cross-linking is performed by way of air moisture, requires a few minutes to hours, depending on the length of time for which the light-emitting device has been operated.

Also in the case of a material that is solely a light-curing material, the joint sealing compound introduced into and skimmed from the joint does not have to be completely cured by the light-emitting device, since the joint sealant is also fully cured by the action of the light provided by the normal lighting of the room and/or by the action of daylight.

Due to the joint sealing compound that is cured in accordance with the present invention into a ready-to-use state at least at the surface by way of the light-emitting device, a time saving of approximately 24 hours is made on construction sites, because with the previous joint sealing materials it was usually standard to wait 24 hours following the sealing of a joint before subsequent work could be performed, or before use could be resumed, since conventional joint sealing material requires a very long curing time.

The joint sealing compound according to the present invention is in particular used for the internal fitting of buildings, transportable structures, or vehicles (for example, mobile homes or campervans, caravans, site trailers, or also boats and the like) and can, for example, be used in sanitary facility and/or kitchen areas.

The joint sealing compound which cures in a dual-curing process can, for example, contain aliphatic urethane acrylate. The joint sealing compound advantageously also contains silica, for example, fumed silica. The joint sealing material in particular contains 3 to 15 wt.-% silica.

The joint sealing material can, for example, contain 35 to 80 wt.-% acrylate, fore example, 60 to 80 wt.-% acrylate.

The joint material can also, for example, contain epoxy resin, methacrylate, auxiliaries, methyloxetanes, silane and dibenzoates individually or in any combination.

The joint material can, for example, additionally contain an epoxy resin, methacrylate and auxiliaries. In addition to the acrylate and the photo-initiator, the joint sealing material can, for example, also in particular contain 8 to 28 wt.-% epoxy resin, and/or 3 to 18 wt.-% methacrylate and/or 1 to 10 wt.-% additives.

A liquid type I photo-initiator which is used at wavelengths of 380 nm is used as photo-initiator.

TPO-L (a trade name from the company Lambson Ltd.) can, for example, be used, i.e., chemical name according to the datasheet: ethyl (2,4,6-trimethylbenzoyl) phenyl phosphinate (also referred to as ethyl phenyl(2,4,6-trimethylbenzoyl)phosphinate; synonyms: 2,4,6-trimethylbenzoylphenylphosphinic acid ethyl ester or ethyl-(2,4,6-trimethylbenzoyl) phenylphosphinate ethyl-(mesitylcarbonyl)phenyl phosphinate).

The joint sealing compound for the dual-curing process can also, for example, contain, individually or in any combination, the following material/the following materials:
methyloxetanes (in particular 3 to 20 wt.-%),
silanes (in particular 0.5 to 5 wt.-%), and
dibenzoates (in particular 5 to 30 wt.-%).

The acrylate-based joint sealing material can contain additional additives, both in the case of the radical system and in the case of the dual-curing system, for example, softeners/plasticizers, thickeners, pigments, dyes, fillers, stabilizers, etc., in particular diethoxyphenylethanone, hexamethyldisilazane, trimethoxyvinylsilane. Additives in this sense are ingredients or aggregates, likewise individually or in any combination.

The joint sealing compound is in particular suitable for the interior fitting of rooms in buildings or also transportable structures or vehicles, such as mobile homes, campervans, site trailers, in shipbuilding and the like, for example, in sanitary facility and/or kitchen areas, for the production of joints (for example, corner joints), in particular if the rooms or areas in which joints are sealed are to be made quickly available again for use following the sealing of the joints.

The joint sealing compound is here a material that cures under the action of a polymerizing radiation and contains at least one photo-initiator in an amount of from 0.5 to 8 wt.-%. The photo-initiator provides that the joint sealing material is cured partially or fully when the joint sealing material is irradiated with radiation in a range of from 300 to 600 nanometers (nm), in particular in the range of from 450 to 480 nm, in particular at 470 nm, and, for example, in a range of from 390 to 410 nm. The at least partial curing of the material is performed within a few seconds to minutes with the aid of a light-emitting device in the form of a polymerization lamp, for example, an LED lamp.

By way of the light-curable and moisture-curable joint sealing compound, a very quick curing of joints filled with said compound can be advantageously achieved. The joint sealing compound for this purpose is filled in the joints, the joints are skimmed over using an appropriate device, for example, a spatula or joint smoothing trowel, and the joint sealing compound is then irradiated with light in a suitable wavelength. An LED lamp is, for example, suitable for this purpose. Light in the near-UV range (but not in the UV range itself) or violet, violet to blue, or blue light can, for example, be used for this purpose. In the case of irradiation with light of a suitable wavelength, the joint sealing compound cures within a few seconds to minutes into a ready-to-use state. The long waiting times of sometimes several days that are standard in the prior art are thereby eradicated.

Joints, in particular connection joints, as are required in the interior fitting of buildings, transportable structures, vehicles or trailers, for example, in mobile homes, campervans, site trailers in shipbuilding and the like in wet areas, for example, in sanitary facility and kitchen areas, are produced with the joint sealing compound according to the present invention.

Connection joints between two different or identical materials, for example, glass, acrylic, stone, tile, ceramic, metal, plastic, plaster, can be produced.

A key advantage of the solution according to the present invention, in the case of the dual-curing process, lies in the fact that, compared to the pure urethane acrylates according to the prior art, by way of the moisture curing a post-cross-linking occurs at points where no light or too little light prevents sufficient curing. The material there remains liquid or gel-like and does not achieve the necessary properties of the end product if no post-curing is performed.

A further advantage of radically curing sealants or sealants curing in the dual-curing process lies in the fact that they are naturally resistant to fungal attack and there is no need to add any poisonous biocides or fungicides.

The joint tool according to the present invention is used to skim over or smooth joint sealing compound material polymerizing as a result of the effect of radiation, wherein the joint tool comprises at least one skimming element defining the shape of the joint and having at least one skimming edge, and the skimming element in accordance with the present invention can be combined with at least one illuminating device which emits a polymerizing radiation.

The illuminating device can, for example, be a polymerization lamp or an LED emitting the polymerizing radiation.

The radiation emitted by the illuminating device can, for example, be a light in a wavelength range of from 300 nm to 780 nm.

The photo-initiator provides that the joint sealing compound in particular cures when the joint sealing material is irradiated with radiation/light in a range of from 300 to 600 nanometers (nm), in particular in the visible light spectrum of from 450 to 480 nm, in particular at 470 nm, and in particular in a range of from 390 to 410 nm, and, for example, at 405 nm. The material cures fully within a few seconds to minutes (for example, within 3 seconds to 10 minutes). This can be achieved, for example, with the aid of a light-emitting device in the form of a polymerization lamp, for example, an LED lamp.

Depending on the material, an independent post-curing, for example, in shaded areas, is possible.

The illuminating device is in particular at least one LED which emits light in the visible wavelength range of from 380 to 490 nm (violet to blue light), via which the joint material cures when light impinges thereon.

The skimming element is advantageously connectable releasably to the illuminating device, for example, by way of a plug-in connection. The illuminating device can alternatively also be fixedly connected to the skimming element.

A grip can furthermore adjoin the skimming element. The illuminating device can also be integrated in the grip or can be fastened to the grip or can be suitable for fastening to the grip. The illuminating device may furthermore also form the grip on which the skimming element is arranged.

It is advantageous that the illuminating device is configured in the form of a flashlight comprising one or more LEDs, wherein the flashlight or a mount provided thereon is connectable to the skimming element, for example, releasably.

The joint tool can comprise one or more skimming elements adapted to different joint shapes.

The present invention also provides a set which consists of the joint sealing compound according to the present invention, a tool for skimming the joint sealing compound introduced into the joint(s), and a light-emitting device, which emits light in a range of from 300 to 600 nanometers (nm), in particular in the range of from 450 to 480 nm, and, for example, in a range of from 390 to 410 nm, and, for example, at 405 nm.

The tool for skimming or smoothing the joint sealing compound and the light-emitting device can be combined to form the tool according to the present invention. The joint spatula or the skimming element can, for example, then be connected to the light-emitting device, in particular releasably.

The present invention will be explained in greater detail below under reference to exemplary embodiments and the associated drawings.

In accordance with a first variant, the joint sealing compound, when clear or at least partially translucent, is solely light-curing (by radical polymerization).

The formulation of this radical system, i.e., the acrylate-based joint sealing compound, which is solely curable by light, consists substantially of the following constituents:
70-95 wt.-% difunctional urethane acrylate,
0-5 wt.-% photo-initiator TPO-L (ethyl (2,4,6-trimethylbenzoyl) phenyl phosphinate),
0-5 wt.-% photo-initiator Keycure 981 (bis(2,4,6-trimethylbenzoyl)-phenylphosphine oxide),
0-5 wt.-% optical brightener Tinopal OB CO (2,5-thiophenediylbis (5-tert-butyl-1,3-benzoxazole),
10-20 wt.-% plasticizer (K-Flex 500), and
1-10 wt.-% silane JH-O174 (3-(methacryloxyl)propyltrimethoxysilane).

The joint sealing compound based on the radical system can also contain fungicide and/or various pigments for coloration, wherein a translucent or at least partially translucent joint sealing compound is provided in spite of the color pigments and can be cured by light in the violet to blue range.

A mixture of different urethane acrylates can also here be used.

This reaction of the curing in a radical process is induced via radiation in the near-UV range (for example, above the UV range) and/or by EB radiation (EB=electrobeam).

Following introduction into the joint, the joint sealing compound is skimmed by a joint spatula. During the skimming or thereafter, the joint is irradiated by a lamp which in particular emits light outside the UV range, in particular light in the violet to blue range. With an irradiation duration of just a few seconds, the joint sealing compound cures, so that the room or the region where a joint has been sealed can continue to be used again or so that other trades can carry out their work.

In a further variant of the formulation of the joint sealing compound according to the present invention, said compound consists in particular of different acrylates which are firstly cross-linked radically and which are then cross-linked by air moisture in a dual-curing process by use of the photo-initiator, for example, TPO-L (a trade name of the company Lambson Ltd.).

The acrylates can be:
aliphatic isocyanate-functional urethane acrylates (light-curing and moisture-curing), optionally in combination with,
aliphatic urethane acrylates (solely light-curing).

The joint sealing compound curing in a dual-curing process can likewise comprise the following constituents:
70-95 wt.-% difunctional urethane acrylate,
0-5 wt.-% photo-initiator TPO-L (ethyl (2,4,6-trimethylbenzoyl) phenyl phosphinate),
0-5 wt.-% photo-initiator Keycure 981 (bis(2,4,6-trimethylbenzoyl)-phenylphosphine oxide),
0-5 wt.-% optical brightener Tinopal OB CO (2,5-thiophenediylbis (5-tert-butyl-1,3-benzoxazole),
10-20 wt.-% plasticizer (K-Flex 500),
1-10 wt.-% silane JH-O174 (3-(methacryloxyl)propyltrimethoxysilane).

Here as well the joint sealing compound based on the radical system can contain fungicide and/or various pigments for coloration, wherein the joint sealing compound is not translucent or is almost not translucent due to the color pigments.

Additives such as plasticizers (for example, dibenzoates), biocides, such as fungicides, thickeners and thixotropic agents, such as hydrophobic fumed silica, adhesion promoters, such as silanes, and auxiliaries, such as aliphatic urethane acrylates, can be added to the acrylates and the photo-initiator (for example, a radical photo-initiator), individually or in combination.

The joint sealing compound in accordance with the present invention in this case thus consists of a dual-curing composite and in accordance with the present invention thus cures by two processes in what is known as a dual-curing process.

This reaction of the first curing process is also induced here by way of radiation in the near-UV range (for example, above the UV range) and/or by EB radiation (EB=electrobeam).

The second curing process of the dual-curing process is a moisture-curing, in particular by an NCO/OH reaction:

R¹—NCO+H₂O→[R¹—NHCOOH]→R¹—NH₂+CO₂,

wherein H₂O comes from the moisture in the air.

The resultant amine reacts then reacts with a further isocyanate group to form a polyurea group:

R¹—NH₂+R²—NCO→R¹—NH—CO—NH—R²

If the precipitation is not complete, the joint sealing compound post-cures within six hours to several days depending on the joint thickness.

At room temperature (for example, at 25° C.), the joint sealing compound is in a pasty state prior to the curing process.

Advantageous embodiments of the use of the joint sealing compound will be described hereinafter:

Here, radiation-curing acrylates, in particular acrylates curing in the near-UV range (with wavelengths above the UV range) and, for example, curing by light in the violet to blue wavelength range, are used with the wavelength range already described to realize the radical process or (in the case of the dual-curing process) the first curing process.

In particular, the radiation-curing silicone acrylates are acrylate-functional pre-polymers. A mixture of:
multi tri-functional silicone acrylate pre-polymer for UV cured systems, and
linear silicone acrylate pre-polymer for UV cured systems,
   can, for example, be used.

The viscosity of the two variants of the joint sealing compound at room temperature (for example, at 25° C.) prior to the curing by UV radiation or other suitable radiation is pasty (pasty ≥20,000 to ≤200,000 mPas).

The joint sealing compound according to the present invention is used in particular for the interior fitting of rooms in buildings or mobile structures, but also in vehicles, moreover, for example, in wet areas such as sanitary facility and/or kitchen areas, but also in laboratory areas and workspaces which, for example, are tiled or otherwise fitted out and in which in particular corner joints or connection joints of wash basins, sanitary fittings, laboratory fittings, cupboards and the like situated between adjacent vertical and horizontal surfaces must be sealed.

Due to the rapid curing of the joint sealing compound, the room in question, in which the joint/joints has/have been sealed, can be quickly released again for use, or can be finished by other trades.

A significant advantage of the solution according to the present invention also lies in the fact that the joint sealing compound is VOC-free (VOC =volatile organic compounds) and therefore does not contain any volatile solvents, which create an unpleasant smell (and are possibly also harmful to health).

The smoothing or skimming of the joint sealing compound introduced into a joint can, for example, be performed by a joint tool, via which the joint sealing compound is cured as the joint is being smoothed.

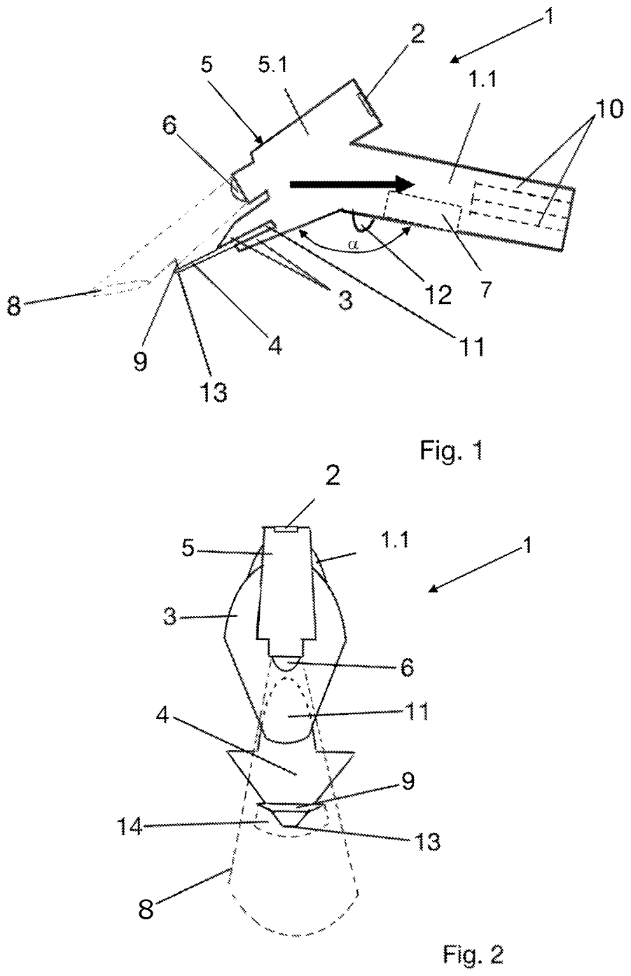

The “gun-like” joint tool 1 shown in FIGS. 1 and 2 comprises a handle 1.1, in which a loading access point 2 for a rechargeable battery (USB, micro USB or the like) is integrated. A receptacle 3 for a skimming element 4 or a smoothing element for skimming or smoothing the joint sealed with the joint sealing material is arranged at the opposite end. The skimming element 4 can be replaced for other skimming elements or smoothing elements.

The housing 5.1 of an LED lamp 5 with at least one illuminating device comprising at least one LED 6 is formed in or on the handle 1.1. The handle 1.1 is also designed to receive a rechargeable battery 7 (or a primary battery). The illuminating body of the LED 6 protrudes from the housing 5.1 on the side facing away from the handle 1.1. When the LED 6 is switched on, it emits a light beam that irradiates an area 8 of the skimmed joint sealing compound (not shown here).

An upwardly pointing element is arranged as a “shade provider” on the skimming element 4 in order to prevent any non-cured joint sealing compound adhering to the skimming element 4 from curing.

One or more compartments 10 for storing different skimming elements 4 is/are provided at the end of the handle 1.1 distanced furthest from the skimming element 4, the handle 1.1, for example, being formed in one part with the housing 5.1 (see FIG. 1).

The housing 5.1 for the LED lamp 5 and the handle 1.1 are inclined at an angle a with respect to one another.

At the other end of the housing 5.1 there is provided a recess 11 for receiving a skimming element 4. The recess 11 can contain a clamping mechanism or the like, which on the one hand provides a secure positioning of the skimming element 4 and on the other hand provides a simple release and exchange of the skimming element 4.

An on/off switch 12 for switching the LED lamp 5 on and off is provided on the underside of the grip 1 of the gun-shaped joint tool 1, so that the LED 6 of the LED lamp 5 can be activated and deactivated easily using the index finger when the hand is holding the joint tool 1 at the handle 1.1.

The skimming element 4 comprises a skimming edge 13, which is designed with various forms according to the sought cross-sectional shape of the joint sealing material (not shown) introduced into a joint (45° joint, 90° joint (right-angle), or semi-circular or other).

A basic diagram of the region 14 shaded by the shade provider 9 can be seen in FIG. 2.

The LED lamp 5 or the LEDs 6 which is/are used in any joint tool 1 can, for example, emit light in the violet to blue or in the blue range, which causes the joint sealing compound to cure (this is also the case in the following exemplary embodiments).

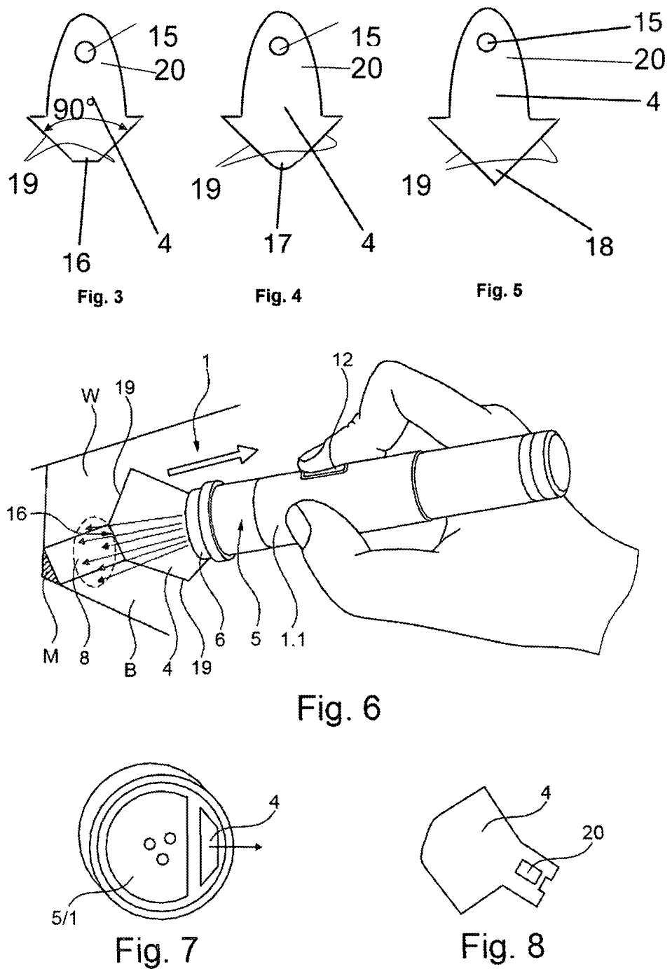

Various types of skimming elements 4 are shown in FIGS. 3-5. In FIG. 3, the skimming element 4 has a straight skimming edge 16 for 45° joints, in FIG. 4, a skimming edge in the form of a radius 17 for joints with a concave form is provided, and in FIG. 5, a skimming edge in the form of a point 19 for 90° joints is provided.

Two side edges 19 running at an angle of 90° with respect to one another (shown only in FIG. 3) extend on either side of the skimming edges 16, 17, 18.

A receptacle 20 that is round in this case and has a latching device 15 extends opposite the skimming edges.

FIG. 6 shows a joint tool 1 with a skimming element 4 which is fastened via a plug-in connection (not shown) to an LED lamp 5 in the form of a flashlight which comprises the LEDs 6. The flashlight or LED lamp 5, together with its housing 5.1, forms the handle 1.1 which is grasped by the hand, wherein the on/off switch 12 for the LEDs is integrated in the handle 1.1.

An illuminated area 8 is produced by the LED(s) 6 and lights up the skimmed joint sealing compound M located after the skimming element 4 as considered in the movement direction (shown by the bold arrow) and thus cures it. A 45° joint is produced by the skimming edge 16, which is straight in this case. The side edges 19 are supported on the floor B and the wall W and are used for guidance.

FIG. 7 shows a further variant of a joint tool which comprises a “can-like” housing 5, with at least one skimming element 6 removable from a storage compartment 10 and a plurality of LEDs 6 in the upper side of the housing 5.

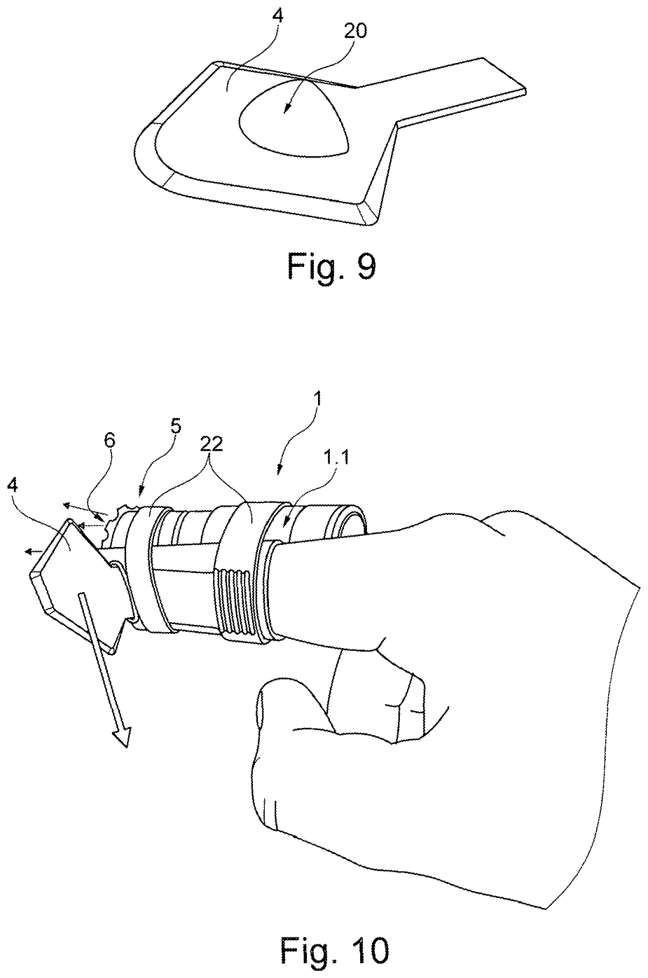

FIGS. 8 and 9 show further variants of a skimming element 4.

In FIG. 8, the skimming element 4 has a right-angled recess formed from the receptacle 20.

In FIG. 9, the receptacle 20 is provided in the form of a depression.

A corresponding element (not shown) of the housing 5 or of the handle 1 engages in the receptacle.

A joint tool 1 formed of LED lamp 5 and a skimming element 4 which can be fitted onto a finger is shown in FIG. 10. One or more LEDs 6 is/are received by a flashlight-like housing 5.1 of the LED lamp 5, which serves as a handle 1.1, so that it can be fastened by a hook-and-loop strap 22 to a finger, here the index finger. The skimming element 4 is here also connected, for example, releasably to the LED lamp 5 (for example, by a plug-in or clip connection).

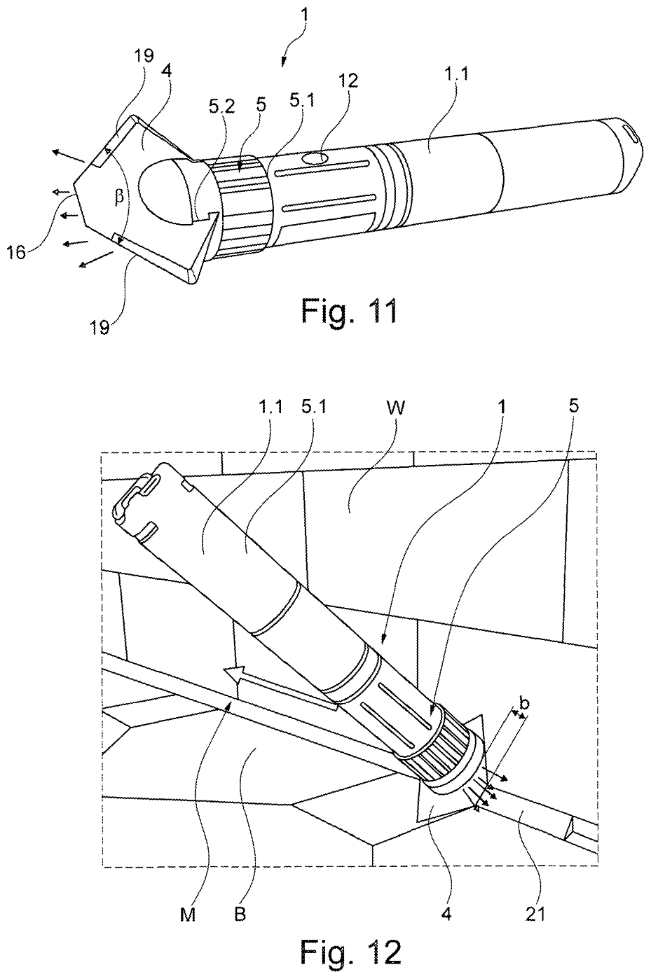

FIG. 11 shows a further variant of a joint tool 1. Here as well a substantially cylindrical handle 1.1 is provided, which is formed by the housing 5.1 of an LED lamp 5 in the form of a flashlight and on the housing 5.1 of which there is provided a receptacle 5.2 for the skimming element 4. The LEDs (not visible here) are situated behind the skimming element 4. A switch 12 for actuating the LED(s)/the LED lamp 5 is provided on the handle 1.1 or the housing 5.1. Here as well the skimming element 4 is connected to the LED lamp 5 via the receptacle 5.2.

The skimming element 4 has a straight skimming edge 16, which extends between the side edges 19 arranged at an angle β of 90° from one another.

The joint tool 1 shown in FIG. 11 is shown in use in FIG. 12. Here a sealed joint 21 filled with joint sealing compound M and smoothed once is run over by the joint tool 1 and cured at least at the surface. The thick arrow shows the direction of movement. The joint tool 1 is held manually at the handle 1.1 in the form of the housing 5.1 of the LED lamp 5 and moves in the direction of the arrow. The joint sealing compound M was introduced beforehand into the connection joint (not denoted) between wall W and floor B and has not yet been smoothed. The joint sealing compound M is smoothed by the skimming element 4 and is cured simultaneously by the LED lamp 5, whereby the finished joint 21 is formed. The distance b between the joint sealing compound to be cured and the LEDs of the LED lamp 5 (not visible here) can, for example, be 0.5 cm to 5 cm. A different distance b can, however, also be selected or set.

If the joint sealing compound M consists of a transparent material, the curing can be performed solely by light, and as the joint tool is advanced slowly onwards, the joint sealing compound M will also be cured fully or practically fully.

If the joint sealing compound M consists of a material which is curable in the dual-curing process, at least the surface of the filled and skimmed joint 21, which has been irradiated with light, is cured, wherein the further curing is achieved by way of moisture curing.

If the wall W, for example, is formed from a transparent material (for example, from glass or transparent plastic), as is often the case in a shower enclosure, it is possible that the filled sealed joint 21 will also be cured by the LED lamp 5 additionally through the transparent wall W. The joint sealing compound M thus also cures immediately in its region adjacent to the wall W. This is possible in the radical process and in the dual-curing process.

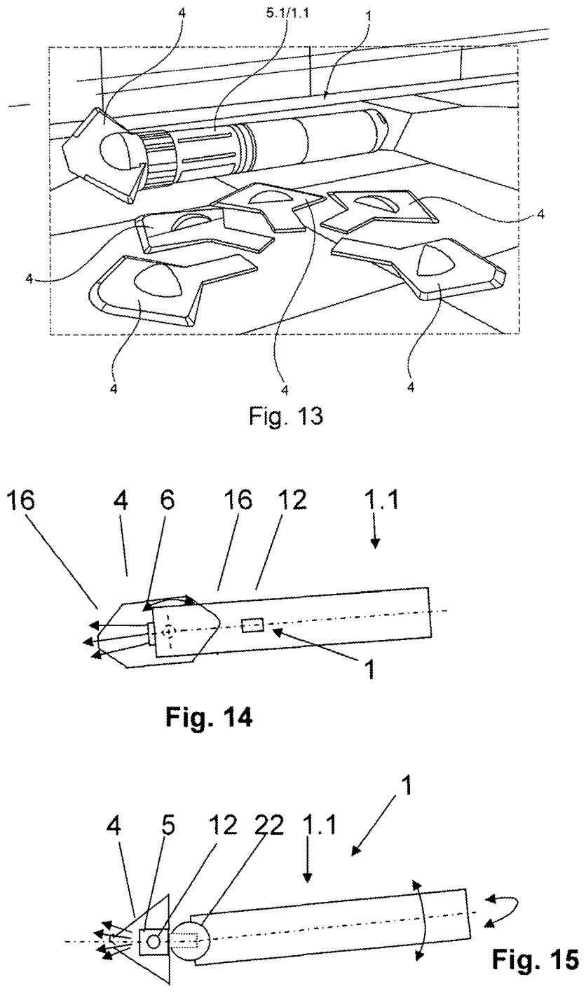

FIG. 13 shows a set of a joint tool 1 formed from flashlight-like LED lamp 5, the housing 5.1 of which forms the handle 1.1 with an assembled skimming element 4 and further non-assembled skimming elements 4 having different skimming edges. The skimming elements 4, can, for example, be releasably connectable to the LED lamp 5 via a plug-in connection.

FIG. 14 shows a joint tool 1 formed of handle 1.1 with one or more LEDs 6 of an LED lamp (not referenced) at the front end and with skimming element 4 received rotatably on the handle 1.1, which skimming element 14 has two different skimming edges 16, which are arranged at an angle of 180° with respect to one another, i.e., opposite one another, and which can be pivoted into the desired position by rotation, depending on the joint shape, and can be locked in this position. The on/off switch 12 for the LEDs 6 is provided in the handle 1.1.

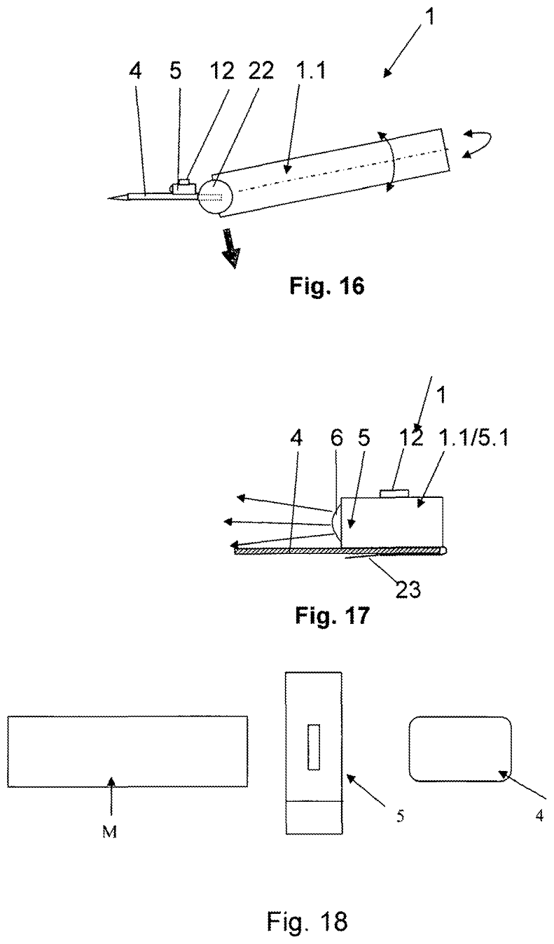

A joint tool 1 with a handle 1.1, via which a skimming element 4 is connected pivotably via a ball joint 22, wherein the LED lamp 5 is fastened to the skimming element 4 and likewise comprises a switch 12, is shown in the plan view in FIG. 15 and in the side view in FIG. 16. The skimming element 4 is here connectable to the ball of the ball joint 22 via a plug-in connection.

The direction of movement is shown in FIG. 16 by the thick arrow.

A further variant of a joint tool is shown in FIG. 17. In this case an LED lamp 5 with an LED 6 is clipped onto a skimming element 14 by a clip 23. The clip 23 is fastened to the handle 1.1, which is formed by the housing 5.1 of the LED lamp 5, and was fastened to the skimming element 4 by the clip 23.

For the first time, with the solution according to the present invention, a skimming element 4 for joint sealing is combined with an illuminating device so as to thus skim off the new light-curing joint material introduced into a joint and at the same time cure it.

A partial curing of the joint sealing compound can here be realized, which makes it possible for the room or area in which the joints were sealed to be released again for use. The further complete curing can then be performed over a longer period of time.

It is of course also possible for the skimming or smoothing of the joint sealing compound M according to the present invention introduced into a joint to be performed by a conventional joint spatula or skimming element 4 and for the joint sealing compound M to then be cured in an additional step by an LED lamp 5 which emits light outside the UV range, in particular in the violet to blue range, by guiding the LED lamp 5 along the joint. A set according to the present invention formed of joint sealing compound M, which is provided in a conventional packaging, LED lamp 5, which emits light in the violet to blue range, and a skimming element 4 is shown in FIG. 18.

It is alternatively also possible to also provide just a set formed of joint sealing compound M and LED lamp 5 or also only a set formed of LED lamp 5 and skimming element 4.

It is likewise possible to provide a set formed of joint sealing compound M according to the present invention with a skimming element 4 and to offer the LED lamp 5 separately.

It is thus possible to cure the material using a single flashlight with the correct wavelength if, after having skimmed or smoothed the joint with the switched-on LED lamp/flashlight, which emits light in the violet to blue wavelength range, the joint is illuminated once more over its entire length, whereby the joint sealing compound M cures at least in part.

The distance of the illuminating device (the LED lamp 5/flashlight) emitting the radiation from the joint sealing compound (M) introduced into the joint and to be cured should be 0.5 cm to 25 cm, for example, 0.5 cm to 10 cm, in particular 0.5 cm to 5 cm.

The present invention therefore also relates to a set formed from joint sealing compound, joint spatula and illuminating device which emits the polymerizing radiation.

The emitted output radiation of the LED lamp or the illuminating device is generally at least 2 watts.

With a high output radiation, the distance of the illuminating device from the joint sealing compound to be cured can be selected to be greater, for example, >5 cm. If the output radiation is lower, the distance from the sealing compound situated in the joint and to be cured should be smaller, for example, ≤5 cm.

The joint sealing material according to the present invention can be introduced into a joint by conventional joint injectors, such as hand-operated guns, cordless applicator guns or compressed air guns.

It is, however, also possible to use a pressurized cartridge containing the joint sealing material according to the present invention.

The present invention for the first time provides an acrylic-based joint sealing compound for wet areas that is light-curing in a radical process (i.e., a radical polymerization) or that is light-curing and moisture-curing in a dual-curing process and thus surprisingly provides rapid curing or partial curing, within a few seconds to minutes, of the joint sealing compound introduced into the joint is provided by the solution.

The present invention is not limited to embodiments described herein; reference should be had to the appended claims.

### LIST OF REFERENCE NUMERALS

1 joint tool

1.1 handle

2 charging access

3 receptacle

4 skimming element

5 LED lamp

5.1 housing

5.2 receptacle

6 LEDs

7 rechargeable battery

8 illuminated area

9 shade provider

10 compartment/storage compartment

11 recess

12 switch

13 skimming edge

14 shaded region

15 latching device

16 straight skimming edge

17 radius of a skimming edge

18 tip of a skimming edge

19 side edges

20 receptacle

21 filled, sealed joint

22 hook-and-loop strap

23 clip

B floor

M joint sealing compound

W wall

b distance between the joint sealing compound M to be cured and the LED lamp

α angle

β angle

What is claimed is:

1-26. (canceled)

27. A joint sealing compound for the in-situ production of connection joints in wet areas, wherein,
the joint sealing compound is based on acrylates, and either,
the joint sealing compound is light-curable only with a light which is outside of the UV range,
or
the joint sealing compound is curable via a dual-curing process wherein the joint sealing compound is moisture-curing with a light which is outside of the UV range.

28. The joint sealing compound as recited in claim 27, wherein,
the joint sealing compound consists of a clear material or a light-permeable material or a translucent material each of which is light-curing with the light outside the UV range, or
the joint sealing compound consists of a substantially light-impermeable material or a material that is not completely translucent each of which is curable via the dual-curing process wherein the joint sealing compound is moisture-curing with the light which is outside of the UV range.

29. The joint sealing compound as recited in claim 27, wherein the joint sealing compound which is curable via the dual-curing process comprises:
an aliphatic isocyanate-functional urethane acrylate that cures via a polymerizing radiation in the form of the light which is outside of the UV range, and
0.5 to 8 wt.-% of at least one photo-initiator.

30. The joint sealing compound as recited in claim 29, wherein the joint sealing compound at least one of,
comprises 20 to 70 wt.-% of the aliphatic isocyanate-functional urethane acrylate, and
further comprises silica.

31. The joint sealing compound as recited in claim 29, wherein the joint sealing compound further comprises an additive selected from one or more of:
a plasticizer,
a biocide,
a thickening agent,
a thixotropic agent,
an adhesion promoter, and
an auxiliary.

32. The joint sealing compound as recited in claim 27, wherein, in the dual-curing process, the joint sealing compound first polymerizes in part under a radical photopolymerization and then, in a further curing process, is post-cross-linked via an NCO/OH reaction.

33. The joint sealing compound as recited in claim 27, wherein the joint sealing compound which is curable via the dual-curing process is at least partially cured via a radiation which is close to the UV range or which is outside of the UV range.

34. The joint sealing compound as recited in claim 27, wherein the joint sealing compound which is curable only with the light which is outside of the UV range cures via a radical polymerization and comprises:
70-95 wt.-% of a difunctional urethane acrylate,
0-5 wt.-% of a photo-initiator TPO-L (ethyl (2,4,6-trimethylbenzoyl) phenyl phosphinate),
0-5 wt.-% of a photo-initiator Keycure 981 (bis(2,4,6-trimethylbenzoyl)-phenylphosphine oxide),
0-5 wt.-% of an optical brightener Tinopal OB CO (2,5-thiophenediylbis (5-tert-butyl-1,3-benzoxazole),
10-20 wt.-% of a plasticizer (K-Flex 500), and
1-10 wt.-% of a silane JH-O174 (3-(methacryloxyl)propyltrimethoxysilane).

35. The joint sealing compound as recited in claim 27, wherein the joint sealing compound is at least partially cured via a radiation which is close to the UV range or which is outside of the UV range.

36. The joint sealing compound as recited in claim 27, wherein the joint sealing compound is in a pasty state at room temperature prior to the curing.

37. A joint tool for at least one of skimming and smoothing a joint sealing compound, the joint tool comprising:
at least one skimming element which defines a shape of a joint, and
at least one illuminating device or is combinable with the at least one illuminating device,
wherein,
the at least one illuminating device is configured to emit a polymerizing radiation,
the at least one illuminating device is at least one of a polymerization lamp or at least one LED lamp which comprise at least one LED, and
the polymerizing radiation emitted by the at least one illuminating device has a wavelength range of from 300 nm to 780 nm.

38. The joint tool as recited in claim 37, wherein the at least one illuminating device is the at least one LED, and the at least one LED emits light as the polymerizing radiation in a wavelength range of from 300 nm to 600 nm.

39. The joint tool as recited in claim 37, wherein,
the at least one skimming element and the at least one LED lamp are releasably connected to one another, or
the at least one skimming element and the at least one LED lamp are fixedly connected to one another.

40. The joint tool as recited in claim 37, further comprising:
a handle,
wherein,
the at least one illuminating device is integrated in, is fastened to, or is fastenable to, the handle, or the at least one illuminating device forms the handle, and
the at least one LED lamp, in a use position, illuminates in a direction of at least one of an edge of the at least one skimming element and in a direction of a region of the joint sealing compound arranged next to the edge of the at least one skimming element.

41. The joint tool as recited in claim 37, wherein the at least one illuminating device is provided as the at least one LED lamp in the form of a flashlight which is connectable to or which is connected to the at least one skimming element.

42. A set consisting of:
the joint sealing compound as recited in claim 27 and a skimming element,
or
the joint sealing compound as recited in claim 27 and an illuminating device which emits a polymerizing radiation,
or
the joint sealing compound as recited in claim 27, a skimming element, and an illuminating device which emits a polymerizing radiation,
or
a skimming element and an illuminating device which emits a polymerizing radiation.

43. The set as recited in claim 42, wherein the skimming element is configured to be combinable with the illuminating device so as to form a joint tool.

44. An illuminating device for curing the joint sealing compound as recited in claim 27, wherein the illuminating device is at least one of a polymerization lamp and an LED lamp each of which are configured to emit a polymerizing radiation which is outside of the UV range.

45. The illuminating device as recited in claim 44, wherein the radiation which is emitted by the illuminating device is light in a wavelength range of from 300 nm to 780 nm.

46. The illuminating device as recited in claim 44, wherein the radiation emitted is at least two watts.
